(19) United States
(12) Patent Application Publication
(10) Pub. No.: US 2010/0332484 A1
(43) Pub. Date: Dec. 30, 2010

(54) DOCUMENT INFORMATION CREATION DEVICE, DOCUMENT REGISTRATION SYSTEM, COMPUTER-READABLE STORAGE MEDIUM AND DOCUMENT INFORMATION CREATION METHOD

(75) Inventor: Shinichi SAITO, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/629,560

(22) Filed: Dec. 2, 2009

(30) Foreign Application Priority Data
Jun. 24, 2009 (JP) 2009-149733

(51) Int. Cl. G06F 17/30

(52) U.S. Cl. 707/757; 707/E17.008

(57) ABSTRACT

A document information creation device including a memory and a creation unit. The memory associates and stores confidential terms and attributes, and stores replacement candidate terms for replacing the confidential terms in association with confidential terms that have pre-specified attributes. The creation unit creates replacement document information by applying at least one of a first replacement, which replaces a confidential term that has a pre-specified attribute with one of the replacement candidate terms, and a second replacement, which replaces a confidential term that has an attribute other than the pre-specified attributes with a term generated from selected characters.

### CROSS-REFERENCE TO RELATED APPLICATIONS

This application is based on and claims priority under 35 USC 119 from Japanese Patent Application No. 2009-149733 filed Jun. 24, 2009.

### BACKGROUND

### Technical Field

The present invention relates to a document information creation device, a document registration system, a computer-readable storage medium storing a program for creating document information and a document information creation method.

### SUMMARY

According to an aspect of the invention, there is provided a document information creation device including: a memory that associates and stores confidential terms that are to be kept confidential and attributes of the confidential terms, and that stores at least one replacement candidate term, which has a pre-specified attribute and is for replacing a confidential term that has the pre-specified attribute, in association with, of the confidential terms, a confidential term that has the pre-specified attribute; and a creation unit that creates replacement document information by applying to document information at least one of a first replacement that replaces a confidential term that is contained in the document information and has the pre-specified attribute with one of the replacement candidate terms stored in the memory, and a second replacement that replaces a confidential term that is contained in the document information and has an attribute other than the pre-specified attribute with a term generated from characters selected from a pre-specified set of characters.

### BRIEF DESCRIPTION OF THE DRAWINGS

Exemplary embodiments of the present invention will be described in detail based on the following figures, wherein:

FIG. 1 is a schematic structural diagram of a document registration system of a present exemplary embodiment.

FIG. 2 is a schematic diagram of a table of confidential terms of the present exemplary embodiment.

FIG. 3 is a schematic structural diagram of a document relay server of the present exemplary embodiment.

FIG. 4 is a schematic diagram of a replacement candidate dictionary of the present exemplary embodiment.

FIGS. 5A and 5B are a flowchart of document information creation processing that is executed by the document relay server of the present exemplary embodiment.

FIG. 6 is a schematic diagram of a table of replacements of the present exemplary embodiment.

FIG. 7 is an example of document information before replacement (after conversion) in the present exemplary embodiment.

FIG. 8 is a diagram for describing an example of document information before replacement and an example of document information after replacement in the present exemplary embodiment.

FIG. 9 is an example of document information before replacement (after conversion) in the present exemplary embodiment.

FIG. 10 is a flowchart of document search processing that is executed by the document relay server of the present exemplary embodiment.

FIG. 11 is a diagram for describing an example of document information after replacement and an example of document information before replacement in the present exemplary embodiment.

### DETAILED DESCRIPTION

Herebelow, an exemplary embodiment will be described in which the present invention is applied to a relay server disposed between a client and a storage server.

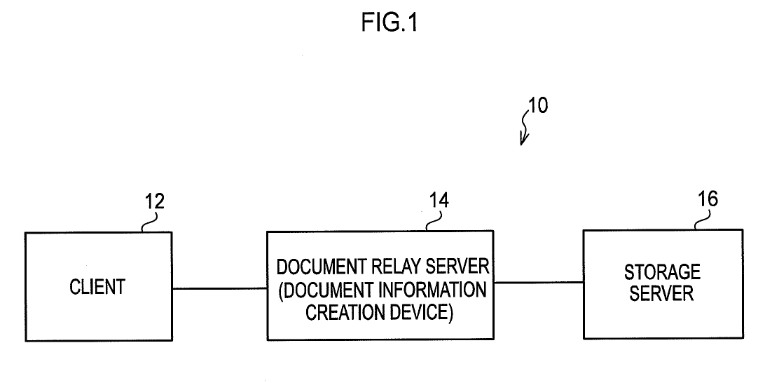

FIG. 1 is a schematic structural diagram of a document registration system 10 of the present exemplary embodiment. The document registration system 10 is equipped with a client 12, a document relay server 14, and a storage server 16 that registers received document information.

The client 12 is equipped with, for example, a reception unit (not shown) for receiving user instructions, such as a keyboard and a mouse or the like; a processing execution unit (not shown) such as a computer or the like that executes processing in accordance with the details of instructions received by the reception unit; and a reporting unit (not shown), such as a display device and a sound output device or the like, for reporting processing results to the user (operator).

The client 12 transmits document information that is an object of registration to the document relay server 14. “The document information that is an object of registration” is document information that is to be registered at the storage server 16, and is document information before processing by the document relay server 14. “The document information” is information (data) of a document. In the present exemplary embodiment, a case in which text data is used as an example of document information will be described.

When, for example, a user ID for identifying a user, confidential terms that are to be kept confidential, and attributes of the confidential terms are inputted to the client 12 via the reception unit, the client 12 prepares a confidential term table 18, illustrated in table 2, in which the user ID, the confidential terms and the attributes are associated. When the client 12 receives an instruction to send the confidential term table 18 to the document relay server 14 via the reception unit, the client 12 sends the confidential term table 18 to the document relay server 14.

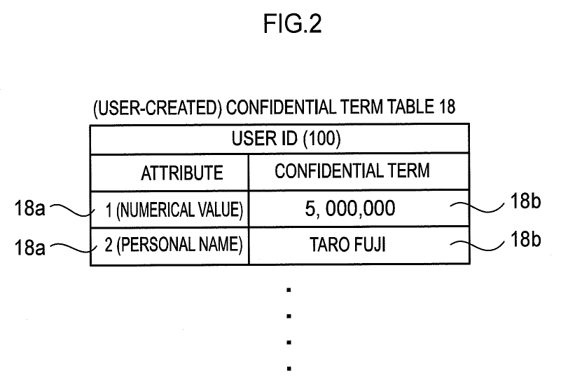

Contents registered in the confidential term table 18 are described in detail with reference to FIG. 2. In the confidential term table 18, confidential terms 18b that are to be kept confidential and attributes 18a of the confidential terms 18b are associated and registered. Via the reception unit of the client 12, a user inputs their own user ID along with a term that is to be confidential in document information, which is a “confidential term”, and inputs an attribute representing what category of term the confidential term is: a numerical value, a personal name, a place name, a company name or the like. The attribute of a confidential term may also be automatically determined by the client 12. When the user ID, confidential term and attribute are inputted, the processing execution unit of the client 12 associates the inputted items of information and registers them in the confidential term table 18. In this manner, the confidential term table 18 is created and the attributes 18a and the confidential terms 18b corresponding to the attributes 18a are registered in respective records.

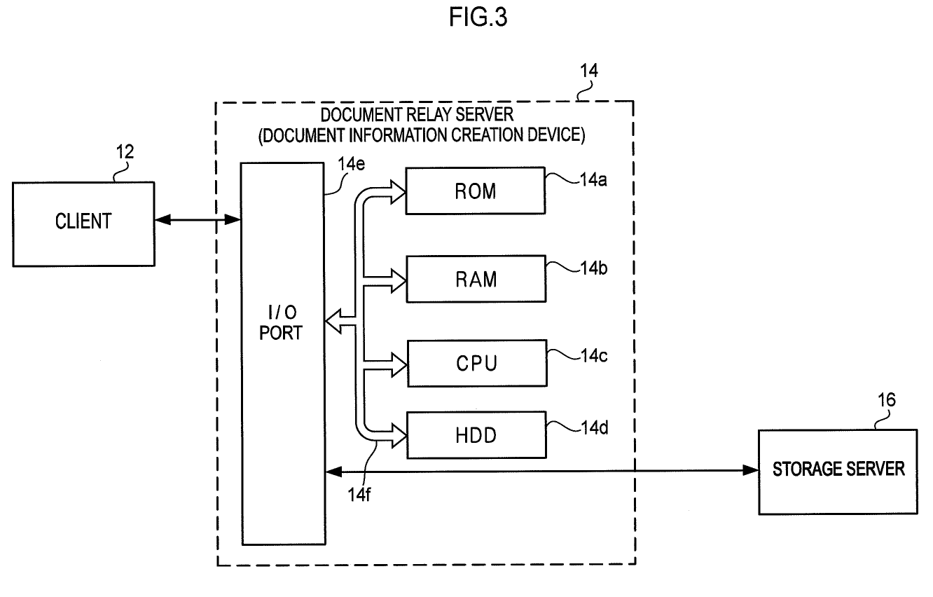

As illustrated in FIG. 3, the document relay server 14 is structured to include a computer equipped with a ROM (read-only memory) 14a, a RAM (random access memory) 14b, a CPU (central processing unit) 14c, an HDD (hard disc drive) 14d, and an I/O (input/output) port 14e. The ROM 14a, RAM 14b, CPU 14c, HDD 14d, and I/O port 14e are connected to one another through a bus 14f. The document relay server 14 functions as the document information creation device.

The ROM 14a serves as a storage medium, in which a basic program such as an OS or the like is stored. The HDD 14d serves as a storage medium, in which programs for executing respective processing routines for document information creation processing and search processing, which will be described in detail later, are stored.

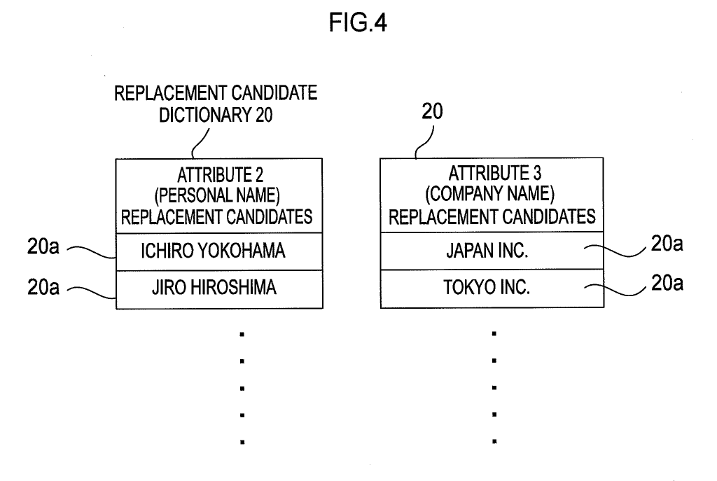

A replacement candidate dictionary 20, illustrated in FIG. 4, is stored in the HDD 14d. Contents registered in this replacement candidate dictionary 20 will be described. In the present exemplary embodiment, one each of the replacement candidate dictionary 20 is stored in the HDD 14d for each of pre-specified attributes among the plural attributes mentioned earlier (for example, in the present exemplary embodiment, attributes other than numerical values (for example, plural attributes representing particular nouns such as personal names, place names, company names and so forth)). A plural number of replacement candidate terms 20a for replacing the confidential terms that have the attribute corresponding to the attribute of the replacement candidate dictionary 20 are registered in the replacement candidate dictionary 20. Herein, the number of the replacement candidate terms 20a registered in a replacement candidate dictionary 20 may be 1.

When the CPU 14c of the document relay server 14 receives the confidential term table 18 from the client 12, the CPU 14c stores the confidential term table 18 in the HDD 14d.

As mentioned above, the confidential terms 18b that are to be kept confidential and the attributes 18a of the confidential terms 18b are stored in correspondence in the HDD 14d of the present exemplary embodiment, and at least one replacement candidate term 20a that has a pre-specified attribute 18a and is for replacing the confidential terms 18b that have the pre-specified attribute 18a is stored in association with, of all the confidential terms 18b, the confidential terms 18b that have the pre-specified attribute 18a. The HDD 14d storing the confidential term table 18 and the replacement candidate dictionary 20 corresponds to a memory.

The CPU 14c reads programs from the ROM 14a and the HDD 14d and executes processing. Various kinds of data are temporarily stored in the RAM 14b.

The client 12 and the storage server 16 are connected to the I/O port 14e.

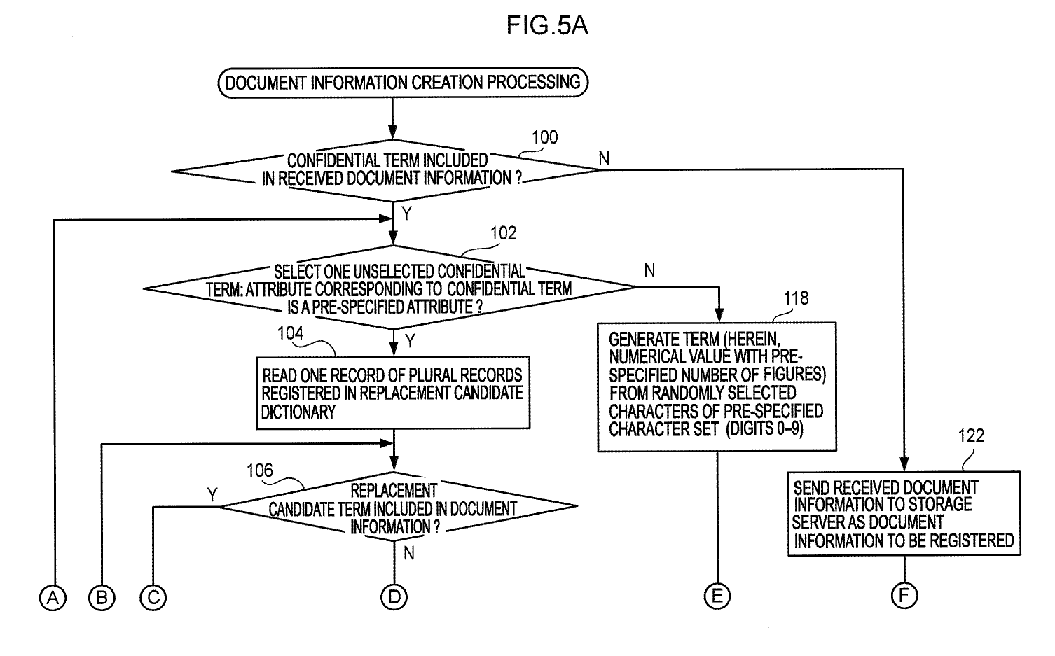

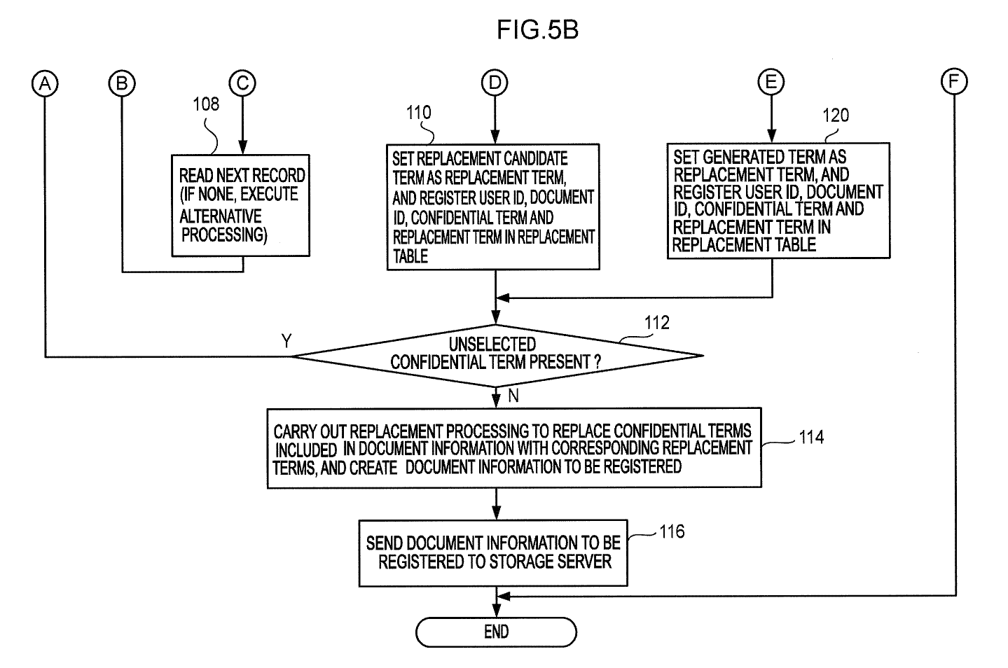

The processing routine of the document information creation processing that is executed by the CPU 14c of the computer of the document relay server 14 will be described using FIGS. 5A and 5B. The document information creation processing is executed by the CPU 14c when document information, an instruction to register the document information in the storage server 16, a user ID, and a document ID for identifying the document information are received from the client 12.

In step 100, it is determined whether or not the confidential terms 18b are contained in the received document information, by searching for whether each of the confidential terms 18b registered in the confidential term table 18 that is stored in the HDD 14d is included in a document represented by the received document information. If a confidential term 18b is included, the confidential term 18b is extracted. Step 100 is an example of extraction processing (an extraction unit). In step 100 and steps subsequent to step 100 that use the confidential term table 18, the confidential term table 18 that is used is the confidential term table 18 that corresponds to the user represented by the received user ID.

If it is determined in step 100 that the confidential terms 18b are not contained in the received document information, the processing advances to step 122. If it is determined in step 100 that a confidential term 18b is contained in the received document information, the processing advances to step 102.

In step 102, on the basis of the registered contents of the confidential term table 18, a single confidential term 18b that has not yet been selected is selected from all confidential terms 18b that are contained in the received document information, and it is determined whether or not the attribute 18a corresponding to the selected confidential term 18b is one of the pre-specified attributes (for example, in the present exemplary embodiment, attributes other than numerical values (for example, plural attributes representing particular nouns such as personal names, place names, company names and so forth)).

If it is determined in step 102 that the attribute 18a corresponding to the selected confidential term 18b is not one of the pre-specified attributes, the processing advances to step 118. If it is determined in step 102 that the attribute 18a corresponding to the selected confidential term 18b is a pre-specified attribute, the processing advances to step 104.

In step 104, the replacement candidate dictionary 20 corresponding to the attribute of the selected confidential term 18b is searched for in the HDD 14d, and one record is read from the plural records registered in the replacement candidate dictionary 20 that is obtained as a result of the search. For example, a first record is read.

In step 106, it is determined whether or not the replacement candidate term 20a registered in the single record that has been read is contained in the document represented by the received document information.

If it is determined in step 106 that the replacement candidate term 20a registered in the one record that has been read is contained in the document represented by the received document information, the processing advances to step 108. In step 108, from the records registered in the replacement candidate dictionary 20 obtained as a result of the search in step 104, one record of records that have not yet been read in the present document information creation processing is read. For example, the next record after the record that has been read is read. Then the processing returns to step 106.

In step 108, if all records registered in the replacement candidate dictionary 20 obtained as the result of the search in step 104 have been read, a message is sent to the client 12 to check for approval or prohibition of registration of the document information in the storage server 16 without confidential terms in the document information having been replaced with replacement candidate terms (for example, “Please select: Register document information in storage server without replacement/Destroy document information without registering”). Hence, the message is displayed at the client 12, and the user returns an instruction approving registration or an instruction not approving registration to the document relay server 14 via the client 12. If the instruction representing approval of registration is received, the document relay server 14 sends the received document information to the storage server 16. Hence, the document information is registered by the storage server 16. If the document relay server 14 receives the instruction not approving registration, the received document information is destroyed, and the present document information creation processing ends.

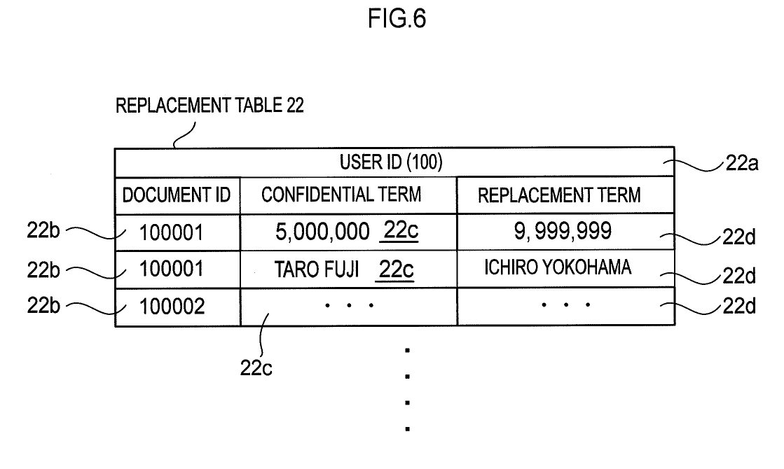

If it is determined in step 106 that the replacement candidate term 20a registered in the one record that has been read is not contained in the document represented by the received document information, the processing advances to step 110. In step 110, the replacement candidate term 20a registered in the single record that has been read serves as a replacement term, and control is carried out so as to store the received user ID, the received document ID, the selected confidential term 18b and the replacement term in association. More specifically, in step 110, as illustrated in FIG. 6, the user ID, the document ID, the selected confidential term 18b and the replacement term are associated and registered in a replacement table 22. Accordingly, a new record is added to the replacement table 22, of a user ID 22a, a document ID 22b, a confidential term 22c and a replacement term 22d. Thus, the confidential term 18b (22c) and the replacement candidate term 20a are stored in association, via the attribute, in the HDD 14d such that the contents carry the meaning that the document information has had the confidential term 22c replaced with the replacement term 22d.

In step 112, on the basis of the contents registered in the confidential term table 18, it is determined whether or not there is a confidential term 18b that has not been selected in step 102 among the confidential terms 18b contained in the received document information. If it is determined in step 112 that there is a confidential term 18b that has not been selected in step 102, the processing returns to step 102. If it is determined in step 112 that there are no confidential terms 18b that have not been selected in step 102, the processing advances to step 114.

In step 114, “document information to be registered” is created by applying replacement processing to the received document information (the registration object document information), to replace the confidential terms 22c contained in the received document information with the corresponding replacement terms 22d. The “document information to be registered” is the document information after this replacement processing has been applied to the received document information, and is information that is to be registered in the storage server 16. The processing when the processing proceeds from step 110 to step 114 is an example of processing of a first replacement; and processing when the processing proceeds from step 120 to step 114, which will be described in more detail below, is an example of processing of a second replacement. Step 114 is an example of creation processing (a creation unit).

In step 116, the document information to be registered that has been created in step 114 is sent to the storage server 16. Hence, the storage server 16 registers the document information to be registered. Then the present document information creation processing ends.

In step 118, a random number (a random value) with a pre-specified number of figures is generated using a pre-specified random number generation algorithm. The pre-specified number of figures may be generated such that, for example, the number of figures is the same as the number of figures of the selected confidential term 18b. The random number may also be generated to have a number of figures greater than or lower than the number of figures of the selected confidential term 18b. At this time, digits may be generated such that zeroes are not contained in leading places, such that the digits seem meaningful. Thus, a term (in this case, a numerical value with the pre-specified number of figures) is generated from characters randomly selected from a pre-specified set of characters (the digits 0 to 9). Another term may be generated if the term generated in step 118 is the same as the numerical value of the selected confidential term 18b, and the generation of terms carried out until the generated term is different from the numerical value of the selected confidential term 18b.

In step 120, control is carried out so as to store the term generated in step 118 as a replacement term, the received user ID, the received document ID, the selected confidential term 18b and the replacement term in association. More specifically, in step 120, as illustrated in FIG. 6, the user ID, the document ID, the selected confidential term 18b and the replacement term are registered in association in the replacement table 22. In this manner, a new record of the user ID 22a, the document ID 22b, the confidential term 22c and the replacement term 22d is added to the replacement table 22. Then the processing advances to step 112.

In step 122, the received document information is sent to the storage server 16 in the form of the document information to be registered. Hence, the storage server 16 registers the document information to be registered. Then the present document information creation processing ends.

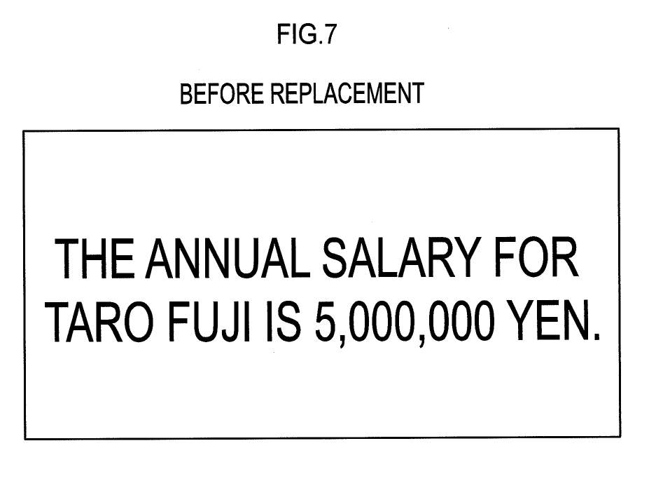

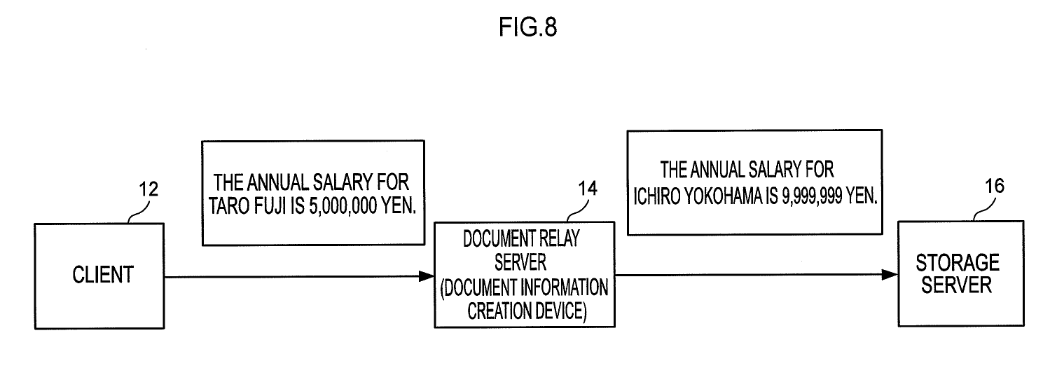

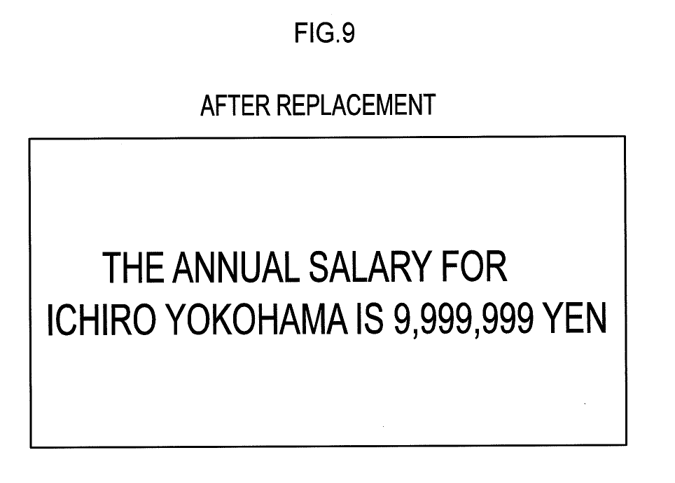

Hereabove, the document information creation processing has been described. It will now be described with a specific example of document information before replacement by the document information creation processing and of document information after replacement. For example, as the registration object document information (the document information before replacement), as illustrated in FIG. 7 and FIG. 8, document information representing the text “The annual salary for Taro Fuji is 5,000,000 yen” is sent from the client 12 to the document relay server 14. In the confidential term table 18, “Taro Fuji” is registered as a confidential term 18b with the attribute 18a being “personal name”, and “5,000,000” is registered as a confidential term 18b with the attribute 18a being “numerical value”. With “Ichiro Yokohama” having been registered as a replacement candidate term 20a in the replacement candidate dictionary 20 corresponding to the attribute “personal name”, as illustrated in FIG. 8 and FIG. 9, document information representing the text “The annual salary for Ichiro Yokohama is 9,999,999 yen” is sent from the document relay server 14 to the storage server 16 as the document information to be registered (the document information after replacement).

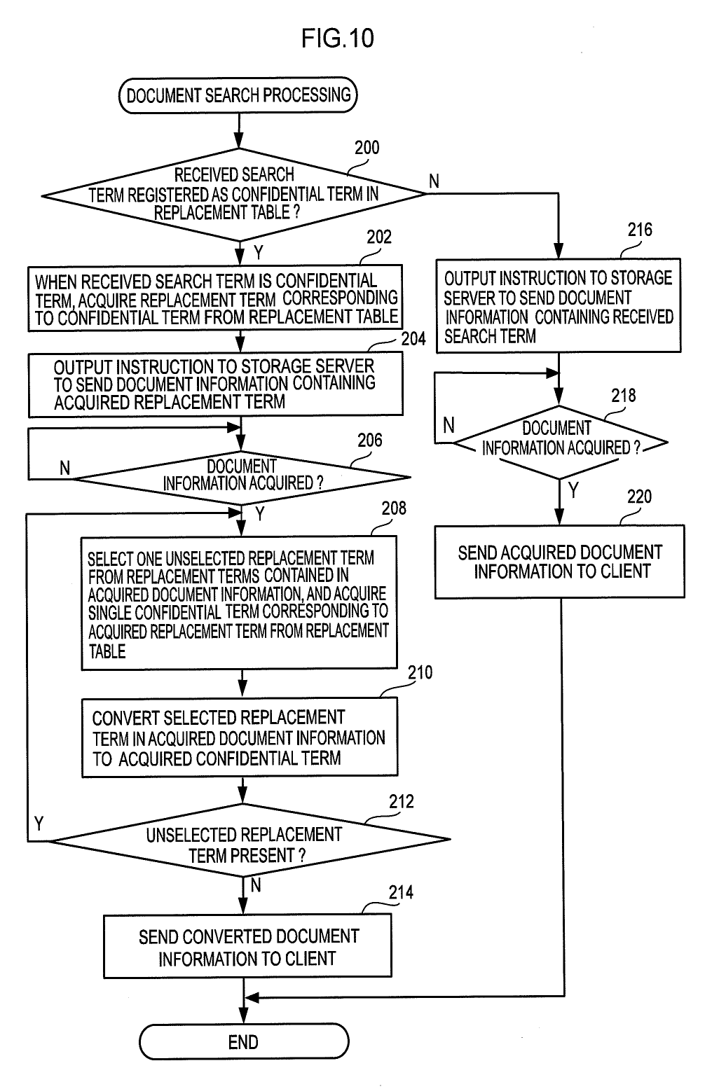

A processing routine of the document search processing that is executed by the CPU 14c of the computer of the document relay server 14 will be described using FIG. 10. The document search processing is executed by the document relay server 14 when a user ID and a search term (search key) are received from the client 12. The search term is, for example, a term for searching for document information that contains the search term among all document information. Document information containing the search information is searched for in all the document information by the document search processing described in detail herebelow, and the document information is sent from the storage server 16 to the client 12 via the document relay server 14.

In step 200, it is determined whether or not the received search term is registered as a confidential term 22c in the replacement table 22. In step 200 and steps after step 200 that use the replacement table 22, the replacement table 22 that corresponds to the user represented by the received user ID is used.

If it is determined in step 200 that the received search term is not registered as a confidential term 22c in the replacement table 22, the processing advances to step 216. If it is determined in step 200 that the received search term is registered as a confidential term 22c in the replacement table 22, the processing advances to step 202.

In step 202, when the received search term is a confidential term 22c, the replacement term 22d corresponding to that confidential term 22c is acquired from the replacement table 22.

In step 204, an instruction to send document information that contains the replacement term 22d acquired in step 202 is outputted to the storage server 16. Hence, in accordance with the instruction, the storage server 16 searches for document information containing the replacement term 22d from among registered document information, and sends document information obtained as a result of the search to the document relay server 14. Thus, by the processing of step 204, the document relay server 14 acquires specified document information from among the document information registered in the storage server 16. In the above-described case, “specified document information” means document information containing the replacement term 22d acquired in step 202.

In step 206, it is determined whether or not document information has been acquired by document information being received from the storage server 16. This determination in step 206 is repeated until it is determined that document information has been acquired from the storage server 16. When the determination of step 206 is that document information has been acquired from the storage server 16, the processing advances to step 208.

In step 208, one replacement term 22d that has not yet been selected is selected from the replacement terms 22d that are contained in the acquired document information, and the one confidential term 22c that corresponds to the selected replacement term 22d is acquired from the replacement table 22.

In step 210, the replacement term 22d that has been selected in step 208 is converted (replaced) in the acquired document information to the confidential term 22c acquired in step 208. Step 210 is an example of conversion processing (a conversion unit).

In step 212, it is determined whether or not a replacement term 22d that has not yet been selected in step 208 is present among the replacement terms 22d that are contained in the acquired document information. If it is determined in step 212 that a replacement term 22d that has not yet been selected in step 208 is present, the processing returns to step 208. If it is determined in step 212 that no replacement terms 22d that have not yet been selected in step 208 are present, the processing advances to step 214. When it is determined in step 212 that no replacement term 22d that has not yet been selected in step 208 is present, all of the replacement terms 22d in the acquired document information have been converted to the confidential terms 22c.

In step 214, the document information in which all the replacement terms 22d have been converted to the corresponding confidential terms 22c is sent to the client 12. Thus, the search object document information is sent to the client 12. Then the present document search processing ends.

In step 216, an instruction to search for document information containing the received search term is outputted to the storage server 16. Hence, in accordance with the instruction, the storage server 16 searches for document information containing the search term from among the registered document information, and sends document information obtained as a result of the search to the document relay server 14. Thus, by the processing of step 216, the document relay server 14 acquires specified document information from among the document information registered in the storage server 16. “Specified document information”, in the above-described case, means document information containing the received search term.

In step 218, it is determined whether or not document information has been acquired by document information being received from the storage server 16. This determination in step 218 is repeated until it is determined that document information has been acquired from the storage server 16. When the determination of step 218 is that document information has been acquired from the storage server 16, the processing advances to step 220.

In step 220, the acquired document information is sent to the client 12. Thus, the search object document information is sent to the client 12. Then the present document search processing ends.

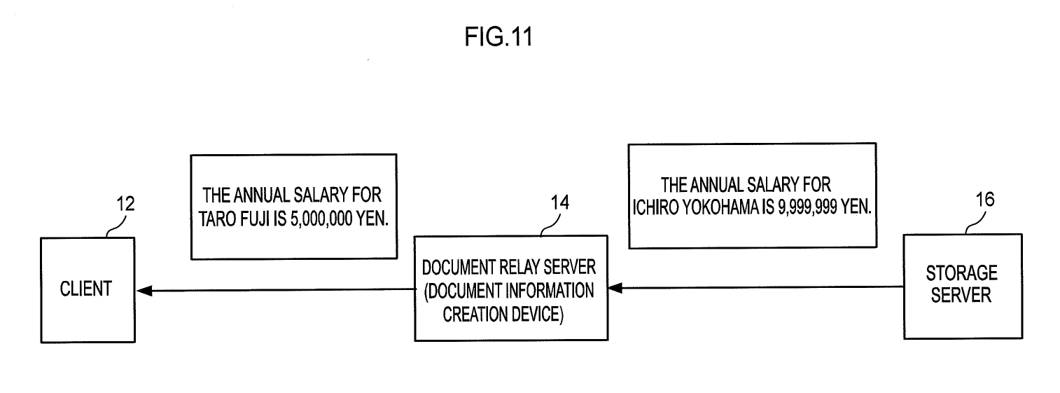

Hereabove, the document search processing has been described. Document information before replacement by the document search processing (the document information to be registered) and document information after replacement (the registration object document information) will now be described. For example, as the document information before replacement, as illustrated in FIG. 9 and FIG. 11, when document information representing the text “The annual salary for Ichiro Yokohama is 9,999,999 yen” is sent from the storage server 16 to the document relay server 14, if the replacement term 22d “9,999,999” and the corresponding confidential term 22c “5,000,000” are registered in the replacement table 22 and the replacement term 22d “Ichiro Yokohama” and the corresponding confidential term 22c “Taro Fuji” are registered in the replacement table 22, then document information representing the text “The annual salary for Taro Fuji is 5,000,000 yen”, as illustrated in FIG. 7 and FIG. 11, is sent from the document relay server 14 to the client 12 as the document information after replacement.

Hereabove, the document registration system 10 of the present exemplary embodiment has been described. In the example that has been described, a document ID is sent from the client 12, but this is not to be limiting. A hash value may be calculated from the document information after replacement, using a pre-specified hash function (for example, SHA-256 or the like), and the calculated hash function may serve as a document ID.

A constitution is possible in which the functions of the document relay server 14 described hereabove are provided at the client 12 or the storage server 16, the document relay server 14 is omitted, and the client 12 and the storage server 16 are directly connected.

A case has been described in which attributes other than numerical values are given as examples of the pre-specified attributes and, in step 118, a term (a numerical value with a pre-specified number of figures in this case) is generated from randomly selected characters from a pre-specified set of characters (the digits 0 to 9), but this is not to be limiting. For example, attributes other than attributes such as personal name, company name and the like may be given as pre-specified attributes and, in step 118, text strings may be generated by randomly selected text strings from a pre-specified set of characters (alphabets, characters of Japanese syllabary Hiragana, Katakana, Japanese Kanji, Chinese characters or the like). Such a case will be suitable if the text strings are generated so as to be intelligible (or meaningful, a person understands a meaning of the text strings), for example, using information from an unillustrated dictionary.

An example in which the client 12 sends the registration object document information to the document relay server 14 in one language (for example, English, Japanese or Chinese) and the confidential terms 22c in the registration object document information are replaced with the corresponding replacement terms 22d by the document relay server 14 to create the document information to be registered, and an example in which specified document information is acquired from among documents registered in the storage server 16 and the replacement terms 22d in the acquired document information are converted to the confidential terms 22c, have been described. However, the document relay server 14 may be provided with a function for translating from a pre-specified language (for example, Japanese or Chinese) to another language (for example, English) and with a function that translates from the other language to the pre-specified language. The document relay server 14 may then translate registration object document information in the pre-specified language to the other language, and replace the confidential terms 22c in the translated document information with the corresponding replacement terms 22d to create the document information to be registered. Specified document information may be acquired from among the document information in the other language that is registered in the storage server 16, with the replacement terms 22d in the acquired document information being converted to the confidential terms 22c, the document information after replacement being translated from the other language to the pre-specified language, and the translated document information being sent to the client 12.

For the document search processing, an example has been described in which an instruction to send document information containing a replacement term 22d is outputted to the storage server 16, the storage server 16, in accordance with the instruction, searches for document information containing the replacement term 22d from among registered document information, and the storage server 16 sends document information obtained as a result of the search to the document relay server 14. However, processing as described below may also be carried out. That is, the document search processing may be executed by the CPU 14c when a user ID and a document ID are received from the client 12, with an instruction to send document information indicated by the document ID being outputted to the storage server 16. In this case, in accordance with the instruction, the storage server 16 searches for the document information indicated by the document ID from among the registered document information, and sends document information obtained as a result of the search to the document relay server 14. Thus, according to this processing, the document relay server 14 acquires specified document information from among the document information that has been registered in the storage server 16. In this case, “specified document information” means the document information indicated by the document ID.

The programs described herein may be saved to and provided on a storage medium, and the programs may be provided by a communications unit. In these cases too, for example, the described programs may fall within the scope of the invention: “a computer-readable storage medium storing a program”.

The term “a computer-readable storage medium storing a program” includes a recording medium on which the program is recorded, which recording medium is readable by a computer and is used for installation of the program, execution, distribution of the program and so forth.

The term recording medium includes, for example: a DVD-R, DVD-RW, DVD-RAM or the like, which are Digital Versatile Discs (DVD) according to standards established by the DVD Forum; a Compact Disc (CD), which is a read-only memory (CD-ROM), CD-Recordable (CD-R), CD-Rewritable (CD-RW) or the like; a Blu-ray Disc (registered trademark); a magneto-optic disc (MO); a flexible disk (FD); a magnetic tape; a hard disc; a read-only memory (ROM); an electrically erasable and programmable read-only memory (EEPROM); a flash memory; a random access memory (RAM); and the like.

The mentioned program or a portion thereof may be recorded on a recording medium and kept in storage, distributed or the like. The program or portion thereof may also be propagated by communication using a propagation medium such as, for example: a wired network or wireless network used in, for example, a local area network (LAN), a metropolitan area network (MAN), a wide area network (WAN), the Internet, an intranet, an extranet or the like; a combination thereof; or the like. The program or portion thereof may also be embodied and carried in a carrier wave.

The mentioned program may be a portion of another program and/or may be recorded on a recording medium together with a separate program. The mentioned program may be split between plural recording mediums and recorded. Further, the mentioned program may be recorded in any mode, such as compression, encryption or the like, as long as the program is restorable therefrom.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to be suited to the particular use contemplated. It is intended that the scope of the invention be defined by the following claims and their equivalents.

What is claimed is:

1. A document information creation device comprising:
a memory that associates and stores confidential terms that are to be kept confidential and attributes of the confidential terms, and that stores at least one replacement candidate term, which has a pre-specified attribute and is for replacing a confidential term that has the pre-specified attribute, in association with, of the confidential terms, a confidential term that has the pre-specified attribute; and
a creation unit that creates replacement document information by applying to document information at least one of
a first replacement that replaces a confidential term that is contained in the document information and has the pre-specified attribute with one of the replacement candidate terms stored in the memory, and
a second replacement that replaces a confidential term that is contained in the document information and has an attribute other than the pre-specified attribute with a term generated from characters selected from a pre-specified set of characters.

2. The document information creation device according to claim 1, further comprising:
a controller that, when at least one of the first replacement and the second replacement has been applied, performs control such that the confidential term before the replacement is applied and the replacement term that replaces the confidential term are associated and stored in the memory; and
a conversion unit that acquires specified document information from the replacement document information created by the creation unit and, on the basis of the confidential term and replacement term that have been stored in the memory, converts the replacement term in the acquired document information to the associated confidential term.

3. The document information creation device according to claim 1, wherein the confidential term and the replacement candidate term are associated and stored such that the replacement document information, after the confidential term has been replaced by at least one of the first replacement and the second replacement, has content that is intelligible, and
the attribute other than the pre-specified attribute and the set of characters include numerals.

4. The document information creation device according to claim 1, wherein the replacement candidate term that replaces the confidential term in the first replacement is a term that is not included in the document information.

5. A document registration system comprising:
a document information creation device that comprises
a memory that associates and stores confidential terms that are to be kept confidential and attributes of the confidential terms, and that stores at least one replacement candidate term, which has a pre-specified attribute and is for replacing a confidential term that has the pre-specified attribute, in association with, of the confidential terms, a confidential term that has the pre-specified attribute, and
a creation unit that creates replacement document information by applying to document information at least one of
a first replacement that replaces a confidential term that is contained in the document information and has the pre-specified attribute with one of the replacement candidate terms stored in the memory, and
a second replacement that replaces a confidential term that is contained in the document information and has an attribute other than the pre-specified attribute with a term generated from characters selected from a pre-specified set of characters; and
a registration device that registers the replacement document information created by the creation unit of the document information creation device.

6. The document registration system according to claim 5, further comprising:
a controller that, when at least one of the first replacement and the second replacement has been applied, performs control such that the confidential term before the replacement is applied and the replacement term that replaces the confidential term are associated and stored in the memory; and
a conversion unit that acquires specified document information from the replacement document information created by the creation unit and, on the basis of the confidential term and replacement term that have been stored in the memory, converts the replacement term in the acquired document information to the associated confidential term.

7. The document registration system according to claim 5, wherein the confidential term and the replacement candidate term are associated and stored such that the replacement document information, after the confidential term has been replaced by at least one of the first replacement and the second replacement, has content that is intelligible, and
the attribute other than the pre-specified attribute and the set of characters include numerals.

8. The document registration system according to claim 5, wherein the replacement candidate term that replaces the confidential term in the first replacement is a term that is not included in the document information.

9. A computer-readable storage medium storing a program causing a computer to execute a process for creating document information, the process comprising:
associating and storing in a memory confidential terms that are to be kept confidential and attributes of the confidential terms;
storing in the memory at least one replacement candidate term, which has a pre-specified attribute and is for replacing a confidential term that has the pre-specified attribute, in association with, of the confidential terms, a confidential term that has the pre-specified attribute; and
creating replacement document information by applying to document information at least one of
a first replacement that replaces a confidential term that is contained in the document information and has the pre-specified attribute with one of the replacement candidate terms stored in the memory, and
a second replacement that replaces a confidential term that is contained in the document information and has an attribute other than the pre-specified attribute with a term generated from characters selected from a pre-specified set of characters.

10. The computer-readable storage medium according to claim 9, the process further comprising:
when at least one of the first replacement and the second replacement has been applied, associating and storing in the memory the confidential term before the replacement is applied and the replacement term that replaces the confidential term;
acquiring specified document information from the created replacement document information; and
converting the replacement term in the acquired document information to the associated confidential term on the basis of the confidential term and the replacement term stored in the memory.

11. The computer-readable storage medium according to claim 9, the process further comprising associating and storing the confidential term and the replacement candidate term such that the replacement document information, after the confidential term has been replaced by at least one of the first replacement and the second replacement, has content that is intelligible,
wherein the attribute other than the pre-specified attribute and the set of characters include numerals.

12. The computer-readable storage medium according to claim 9, wherein the replacement candidate term that replaces the confidential term in the first replacement is a term that is not included in the document information.

13. A document information creation method comprising:
associating and storing in a memory confidential terms that are to be kept confidential and attributes of the confidential terms;
storing in the memory at least one replacement candidate term, which has a pre-specified attribute and is for replacing a confidential term that has the pre-specified attribute, in association with, of the confidential terms, a confidential term that has the pre-specified attribute; and
creating replacement document information by applying to document information at least one of
a first replacement that replaces a confidential term that is contained in the document information and has the pre-specified attribute with one of the replacement candidate terms stored in the memory, and
a second replacement that replaces a confidential term that is contained in the document information and has an attribute other than the pre-specified attribute with a term generated from characters selected from a pre-specified set of characters.
